(19) United States
(12) Patent Application Publication
(10) Pub. No.: US 2021/0110037 A1
(43) Pub. Date: Apr. 15, 2021

(54) MALWARE DETECTION SYSTEM

(71) Applicant: INTERNATIONAL BUSINESS MACHINES CORPORATION, Amonk, NY (US)

(72) Inventors: Guerney D.H. Hunt, YORKTOWN HEIGHTS, NY (US); Elaine R. Palmer, Hanover, NH (US); Gregory A. Porpora, New Fairfield, CT (US); Aaron Potler, Bethesda, MD (US)

(21) Appl. No.: 16/599,111

(22) Filed: Oct. 10, 2019

(51) Int. Cl. G06F 21/56; G06F 21/55; G06F 16/25; H04L 29/08; G06F 16/248; G06F 16/27

(52) U.S. Cl. CPC G06F 21/566; G06F 21/552; G06F 16/27; H04L 67/1097; G06F 16/248; G06F 16/258

(57) ABSTRACT

An embodiment of the invention may include a method, computer program product, and computer system for monitoring a computing device. The embodiment includes retrieving data from physical components of the method. The embodiment includes converting the data to at least one spectral format. The embodiment includes analyzing the converted data with a spectral detector. The embodiment includes performing a remediation action of the code anomaly based on detecting a code anomaly by the spectral detector.

### BACKGROUND

The present invention relates to a Malware Detection system, and more specifically, to a system that is able to detect and isolate metamorphic threats to physical IT infrastructure, data, operating system and applications.

Malware is any software intentionally designed to cause damage to a computer, server, client, or computer network. Malware does the damage after it is implanted or introduced in some way into a target's computer and can take the form of executable code, scripts, active content, and other software. The code is described as computer viruses, worms, Trojan horses, ransomware, spyware, adware, and scareware, among other terms. Malware can be inserted from external threats, internal threats and compromised supply chain. Malware has a malicious intent, acting against the interest of the computer user.

### BRIEF SUMMARY

An embodiment of the invention may include a method for monitoring a computing device. The method includes retrieving data from physical components executing the method. The method includes converting the data to at least one spectral format. The method includes analyzing the converted data with a spectral detector. The method includes performing a remediation action of the code anomaly based on detecting a code anomaly by the spectral detector.

Another embodiment of the invention provides a computer program product for monitoring a computing device. The computer program product includes retrieving data from physical components executing the computer program product. The computer program product includes converting the data to at least one spectral format. The computer program product includes analyzing the converted data with a spectral detector. The computer program product includes performing a remediation action of the code anomaly based on detecting a code anomaly by the spectral detector.

Another embodiment of the invention provides a computer system for monitoring a computing device. The computer system includes retrieving data from physical components of the computer system. The computer system includes converting the data to at least one spectral format. The computer system includes analyzing the converted data with a spectral detector. The computer system includes performing a remediation action of the code anomaly based on detecting a code anomaly by the spectral detector.

### BRIEF DESCRIPTION OF THE DRAWINGS

FIG. 1 is a block diagram depicting the hardware components used by and protected by the Malware Detection system of FIG. 2, in accordance with an embodiment of the invention.

FIG. 2 illustrates a Malware Detection system, in accordance with an embodiment of the invention.

FIG. 3 illustrates a Malware Detection System process flow, in accordance with an embodiment of the invention.

FIG. 4A illustrates a Data Monitoring process flow, in accordance with an embodiment of the invention.

FIG. 4B illustrates a Data Analysis process flow, in accordance with an embodiment of the invention.

FIG. 5 illustrates a Spectral Detectors Training process flow, in accordance with an embodiment of the invention.

FIG. 6 illustrates a Classification Module Training process flow, in accordance with an embodiment of the invention.

FIG. 7 illustrates a Classification Module process flow, in accordance with an embodiment of the invention.

FIG. 8 illustrates a Spectral Detector process flow, in accordance with an embodiment of the invention.

FIG. 9 illustrates a Quarantine Processor process flow, in accordance with an embodiment of the invention.

FIG. 10 illustrates a Malware Tracker process flow, in accordance with an embodiment of the invention.

FIG. 11 illustrates a User Event Monitor process flow, in accordance with an embodiment of the invention.

### DETAILED DESCRIPTION

Embodiments of the present invention will now be described in detail with reference to the accompanying Figures.

The Malware Detection System (MDS) is an outgrowth of the recent Spectre and Meltdown covert-channel privilege escalation exposures impacting almost every IT architecture in the world. IT Infrastructure is the new Battle Space with microarchitecture attacks due to Polymorphic and Metamorphic Malware coupled with privilege escalation exposures from Spectre & Meltdown and other covert channels. This solution is designed to address attacks on IT hardware (core processor and associated components), peripherals and their respective firmware and bios infrastructure resulting from Polymorphic and Metamorphic Malware (running in either a file system or memory) that has the ability to change its internal structure without altering behavior-execution, or sneak in malicious code into Portable Executable (PE) files, that is targeted to take down the infrastructure from the inside out. What we mean by this, is taking down physical infrastructure (i.e. Denial of Service through reboot, causing race conditions, Bios and Firmware overwrite, attack on system management modules to turn off fans and cause thermal overloads, shut down power supplies, data encryption, threshold modification, etc.). This is the reason this is classified as a Micro Architecture based Attack versus traditional Macro Architecture based attacks that target operation systems, networks, application and data repositories. Today there is no effective means to detect this class of Micro-Attack with current Anti-Virus (AV), Intrusion Prevention and/or Intrusion Detection technology. In addition to the current lack of effective detection capability, once detected there is no effective means to quarantine the malware before damage is inflicted. Current AV tools employ signature-Hash and/or Heuristics based (Rules, and/or Weight based) approaches which can easily be defeated by Polymorphic-Metamorphic malware and always suffer a time gap between releases versus Feature based detection. In just 1-2 iterations employing both encryption and/or obfuscation techniques these malwares can 100% transform from their original insertion form, making them impossible to detect with current techniques

Foundational attacks due to flaws in processor design, along with polymorphic and metamorphic malware represent new vulnerabilities in computer systems that need to be accounted for. Traditional virus detection systems are unable to address such attacks, as they typically scan a computer system for code or behaviors from a known library of threats. However, polymorphic and metamorphic malware may constantly change, and thus traditional techniques using virus definition as a mechanism to compare code located in the hardware may be obsolete by the time they are implemented and have no bearing on the security of the system.

Embodiments of this invention may include a system that focuses on identifying and isolating malware that use foundational attacks, or attacks on the hardware itself, instead of traditional attacks targeting operating systems, networks, applications or data repositories. Such attacks may include, for example, denial of service through reboot, causing race conditions, BIOS and firmware overwrite, attack on system management modules to turn off critical systems (for example, fans) to induce device malfunction, shut down power supplies, data encryption, threshold modification, and loss of data through compromised adapter firmware.

Embodiments of this invention may improve upon previous techniques by analyzing components of the system through a variety of different means. The detection system may monitor components such as, for example, the file system, memory, firmware, network communications, for inconsistencies or threats, and may take appropriate action on files that are deemed to be a threat. Such inconsistencies or threats may be determined by analyzing component level data from one or more sources, performing an initial format conversion or feature extraction, and feeding the data into a trained detector ensemble for analyzing the data in real time. In some embodiments, objects causing the inconsistencies or threats may be physically isolated from the rest of the system under analysis and monitored to gain additional insights on the threat.

Due to the complexity and nature of the threats, a system for information discovery in a high entropy system is necessary. By employing multiple inputs, analysis techniques, and detector systems, obfuscated or encrypted threats that may have previously avoided detection may be discovered and handled accordingly.

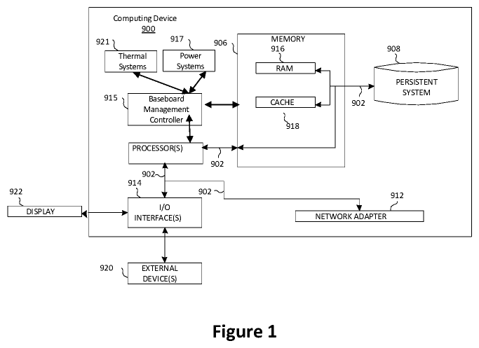

FIG. 1 depicts a block diagram of components of computing device 900, in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made.

Computing device 900 includes communications fabric 902, which provides communications between computer processor(s) 904, memory 906, persistent storage 908, communications unit 912, and input/output (I/O) interface(s) 914, Baseboard Management Controller 915, Thermal System 921, Power System 917 Communications fabric 902 can be implemented with any architecture designed for passing data and/or control information between processors (such as microprocessors, FPGA's, GPU's, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes Random Access Memory (RAM) 916 and cache memory 918. In general, memory 906 can include any suitable volatile or non-volatile computer-readable storage media.

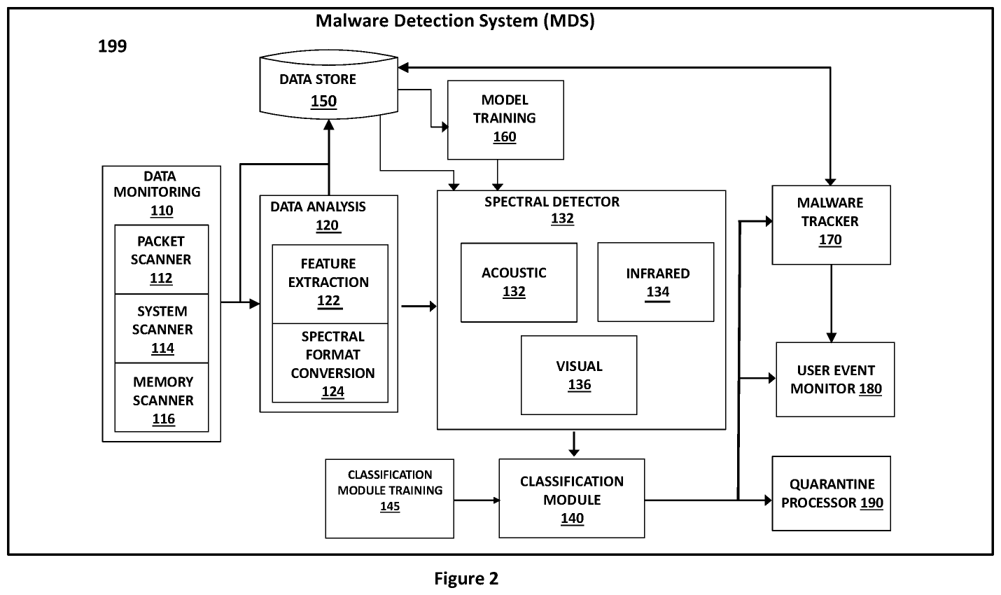

The program Malware Detection system 199 (see FIG. 2) of computing device 900 may be stored in persistent storage 908 for execution by one or more of the respective computer processors 904 via one or more memories of memory 906. In this embodiment, persistent storage 908 includes a magnetic hard disk drive. Alternatively, or in addition to a magnetic hard disk drive, persistent storage 908 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Communications unit 912, in these examples, provides for communications with other data processing systems or devices. In these examples, communications unit 912 includes one or more network interface cards. Communications unit 912 may provide communications through the use of either or both physical and wireless communications links. The program Malware Detection system 199 (see FIG. 2) of computing device 900 may be downloaded to persistent storage 908 through communications unit 912.

I/O interface(s) 914 allows for input and output of data with other devices that may be connected to computing device 900. For example, I/O interface 914 may provide a connection to external devices 920 such as a keyboard, keypad, a touch screen, and/or some other suitable input device. External devices 920 can also include portable computer-readable storage media such as, for example, thumb drives, portable optical or magnetic disks, and memory cards. Software and data used to practice embodiments of the present invention, for example, the program Malware Detection system 199 (see FIG. 2) of computing device 900, can be stored on such portable computer-readable storage media and can be loaded onto persistent storage 908 via I/O interface(s) 914. I/O interface(s) 914 can also connect to a display 922.

Display 922 provides a mechanism to display data to a user and may be, for example, a computer monitor.

Power system 917 includes components of computing device 900 that provided power to all electrical subsystem, circuit cards and internal displays systems.

Thermal system 921 includes fans, and/or other cooling devices, as well as and thermal monitoring and auto protection mechanism provides cooling and protection in the event of a thermal overload.

The Baseboard Management Controller (BMC) 915 is a specialized service processor that monitors and controls the physical state of a computer, network server or other hardware devices such as fans, thermal protection, power supply using sensors that may implement the Intelligent Platform Management Interface (IPMI) and communicates with the system administrator.

FIG. 2 illustrates a malware detection system 199, in accordance with an embodiment of the invention. In an example embodiment, malware detection system 199 includes a data monitoring program 110, data analysis program 120, spectral detector 132, classification module 140, data store 150, model training 160, malware tracker 170, user event monitor 180, and quarantine system 190.

Data monitoring program 110 may include one or more monitoring components, such as packet scanner 112, system scanner 114, and memory scanner 116, that monitor the physical components of the system under analysis depicted in FIG. 1, as well as data or commands issued to the system under analysis. Data monitoring or scanning of packets, system, and/or memory may be performed as a background task to minimize performance impacts on the system under analysis and on a continuous basis. The scans using the modules of data monitoring program 11 may be scheduled to ensure the least trade-off impact on real-time application performance versus detection. In an embodiment, scans by data monitoring program may be performed at Boot-up, during software updates, and daily full scan of memory (e.g., cache, ROM, firmware-Bios, flash memory, SRAM, DRAM). Files that have undergone the scan will be given a hash signature to base line them as part of the malware tracking function. Files determined to be clean-benign will be tagged and only rescanned at boot-up or during software updates whereby their respective hash will be checked and if different will be rescanned and captured for analysis. Memory will always be scanned to avoid detection. Any files that fail benign hash validation will be stored as historical data store for off-line deep forensic analysis

While depicted as containing multiple scanners: packet scanner 112, system scanner 114, and memory scanner 116, data monitoring program 110 may operate using one or more of these scanners. The results of data monitoring are fed into Data Analysis 120 and data store 150.

Packet scanner 112 may scan internal data packets moving along communications fabric 902 of the computing system 900. Such data scans of packets may retrieve information such as, for example, packet size, the source of the packet, the destination of the packet, whether a packet is encrypted, or any other related information to the packet. Packet scanner 112 feeds the Feature Extraction 122 module with captured packet data. Representative features include but are limited to PE header descriptors, code strings, specific operands and commands, special characters, N-gram analysis, control flow analysis, negative heuristic analysis, string hash signatures, and other statistical analysis.

System scanner 114 may scan the file system located in persistent system 908 of computing device 900. The system scanner may scan file names, file sizes, locations, encryption, and any other relevant file characteristics.

Memory scanner 116 may scan the memory 906 of the computing device 900. Computing devices may include not only main computing device but also all peripheral devices such as network cards, hard drives, etc., anything that contains firmware. Memory scanner 116 may detect program names using memory, the amount of memory used by a program, read/write operations carried out by such programs, and any other relevant file characteristics.

Data analysis program 120 may include one or more data preparation modules, such as feature extraction module 122 and spectral format conversion 124. The results of data analysis may be fed into the spectral analysis module 132 and the data store 150.

Feature extraction module 122 can work in concert with the spectral format conversion module 124. Data analysis processes the outputs from data monitoring into multiple data sets that may be specific to one or more of the detectors. For example, it can take each scanned memory and/or file binaries and apply detector specific methods to extract key features as inputs for AI based models. A frequency detector of the Spectral format conversion module 124 may extract frequency, amplitude and phase of opcodes, code strings of known functionality, system calls, API calls or function calls. This may be done by applying a hamming window to the binary file to compensate for spectral leakage and then apply a Discrete Fourier Transform (DFT). Additionally, an image processing detector of spectral format conversion module 124 may convert binaries to Gabor and GIST features, which also represents specific operands (individually or collectively), code strings of known functionality, system calls, API calls or function calls. Further, the entropy detector of spectral format conversion module 124 may apply Dyadic Wavelet Transform (DWT) and Shannon entropy calculations to extract entropy transition and value coefficients features for machine and deep learning models. By converting raw data in this manner, feature extraction module 122 in concert with the spectral conversion module 124 enables the spectral analysis module 132 to ingest the extracted and formatted features and perform the classification and scoring analysis (benign, malicious, suspicious) based on the respective detector class.

Spectral format conversion module 124 may convert file binaries into spectral formats. In an example embodiment, the three spectral formats may include: acoustic 132 (frequency), infrared 134 (heat maps for entropy) and visual 136 (image processing). These three sub-detectors may compose the spectral detector ensemble, although additional detectors may be included.

Spectral analysis 132 analyzes the data spectrally. Spectral analysis 132 is able to classify obfuscated, packed and/or encrypted code designed to evade classical code string and heuristic analysis techniques. Spectral analysis is utilized to uncover subtle, low observable anomalies in code that is inconsistent with normal environmental attributes and behavior. This detector class extracts information from a high entropy environment. Spectral analysis 132 analyzes binaries from one or more perspectives: Acoustic (Frequency), Infrared (Heat maps for entropy) and Visual (image processing). Spectral analysis 132 is able to detect code anomalies that may fit signatures of malware in situations where a score based on the attributes and behavior of the code anomaly is above a threshold level for the given malware threat (e.g., suspicious, malicious).

Data Store 150 may act as a repository of all data coming from data monitoring program 110 and data analysis module 120. Data Store 150 may contain results about benign, malicious, or suspicious samples from the other components in the system such as data analysis module 120, malware tracker 170, and model training module 160. Data store 150 may contain histories of activity of specific programs, specific states of the computing device, or any other relevant activity logs that can be referred to, or used by model training module 160, to improve spectral detector 132. Additionally, data store 150 may contain the preferred models for use by the spectral detector 132. Further, data store 150 may contain detected malware, quarantined malware, flagged hardware, flagged programs, and any other information related to detecting ongoing threats to the system under analysis, computing device 900. It is important to note that the Malware Detection System operates on all computing devices 900 in an infrastructure, for example the infrastructure of a cloud provider or a company. There is a Data Store 150, that records the data from all operating instances. Data recorded in the Data Store 150 also indicates the system from which the data originated. Data store 150 is a persistent storage medium, and may be secured against attacks and unauthorized modification of the data.

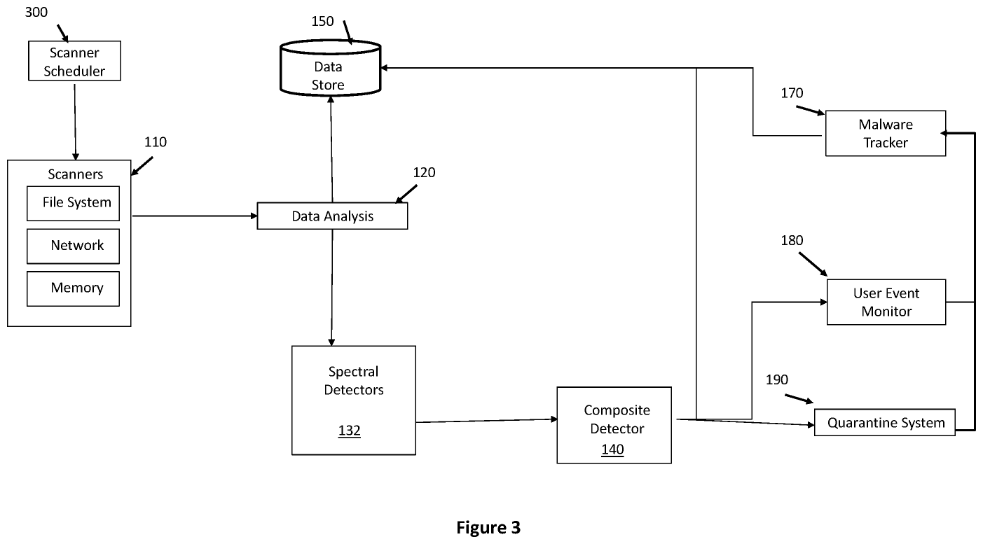

Model training module 160 may train the spectral analysis module 132 module prior to operation, or retrain the spectral analysis module 132 in real time, based on classified data and patterns contained in data store 150. Trained models may be both malware family specific with variation comparison, as well as general feature centric to detect previously undetected malware. For model training, pre-conditioning techniques such as down sampling, filtering, and block size averaging may be employed as the size of the data being analyzed may vary greatly which may impact feature extraction. Training approaches may include: Caffe-based convolutional neural nets deep learning employing forward learning techniques, SigMal Static signal processing-based triage, R and SPSS modeler, Python based Libraries, N-Graphs strings. Further mechanisms of model training module 160 may be depicted with respect to FIG. 3.

Malware tracker 170 may determine whether malicious and/or suspicious objects, identified by the spectral analysis module 132 have migrated to different components of the system under analysis such as peripherals, computer system 900 or new malware has been introduced from external means. It also analyzes whether the malware is related to known malware by derivation or transformation. Malware may transform itself through code morphing to avoid detection but is effectively the same malware (family) versus another malware. A co-occurrence classification method may be employed.

User event monitor 180 may receive alerts from other components in the malware detection system. These alerts include detection of malicious and/or suspicious code confirmed by the spectral analysis module 132 as well as any quarantine responses from the Quarantine Process 190. The contents of the alerts will be logged, conveyed to a user through an interface, or sent to another system for analysis. This information includes but is not limited to ID number, confidence score and location in computing system 900 of the malicious-suspicious entity and any instituted quarantine activity.

Quarantine system 190 may apply any number of software and/or hardware techniques to neutralize and isolate suspected threats. The quarantine techniques may be based on the architecture and the components located in the system under analysis. For example, the quarantine may include erasure of the threat, isolation of the infected memory, isolation of the infected hardware component, isolation of the process running the threat, and/or shutting down or rebooting the system under analysis.

FIG. 3 depicts the MDS overall process flow during normal operation in a targeted information technology (IT) architecture. This figure illustrates the process flow from left to right of a complete end-to-end system scan to detect, track, log detected anomalous code and if necessary, quarantine and alert if the anomalous code is determined to be malware. All processing starts with scanner scheduler 300 the scanner scheduler which is the commands data monitoring module 110 that houses the three system scanners (file system, memory, internal network). The scanner scheduler 300 scanner may run as a background task completing end-to-end scanning and reading of files, memory and network traffic. The scanner scheduler 300 scanner may pre-empt operating applications if any one or more of the following conditions are detected: A firmware update, a new file has been added or a new peripheral-hardware component has been added. Pre-emption criteria may be fixed or dynamically established by policy. If a condition has been detected by Scanner scheduler 300 then data monitoring module 110 performs the respective scanner to first start scanning and tagging with a unique ID tag those memory, files or peripherals that have been updated then the remainder of the mapped entities (files, memory). This captured information will be sent to module 120 for extraction and data normalization. Module 120 will then store the ID tags in the Data Store 150 and send the extracted features to the spectral analysis module 132 for analysis and scoring. The results the spectral analysis module 132 will be sent to classification module 140 for final classification of each ID tag into one of three classes (benign, malicious, suspicious). Benign results will be dropped, suspicious and malicious results will be stored in the Data Store 150. Suspicious results will be sent to user event monitor 180 to send out an alert to the system administrator. An example of alert information includes entity ID and associated metadata (overall score by detectors, location, time). Suspicious detection will be sent to malware tracker 170 for tracking and comparison to potentially previously detected suspicions and/or malicious detections. If the output of classification module 140 is confirmed as malicious, it will be sent to quarantine system 190 the quarantine processor. Module 190 determines the appropriate quarantine approach (for example, deletion, isolation, system shut down, peripheral access denial) and alerts the system administrator. Malicious malware will be sent to module 170.

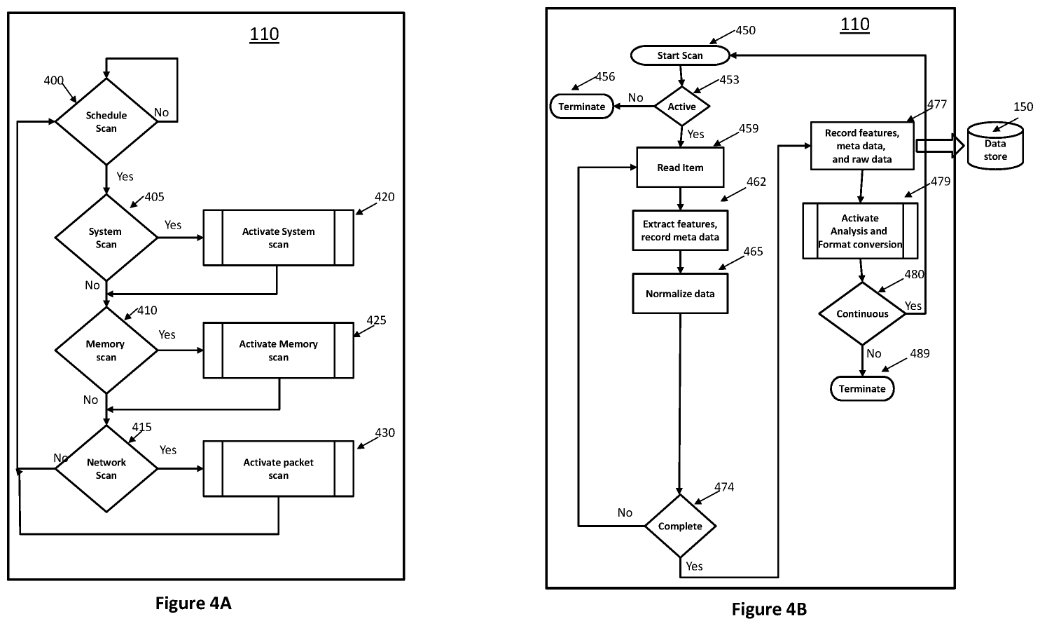

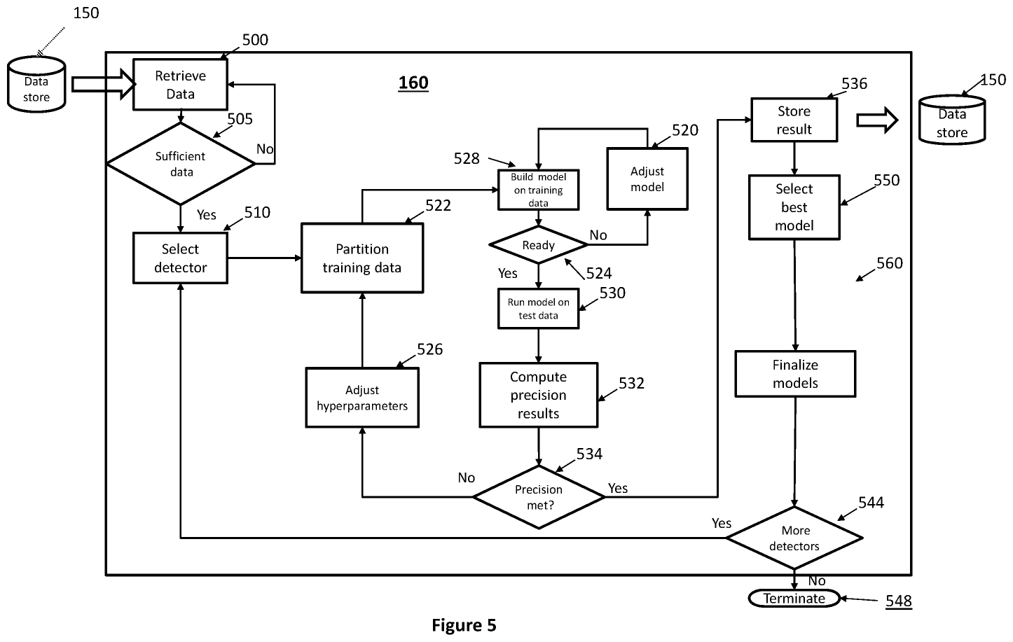

FIG. 4A illustrates functions of the Data Monitoring module 110. At step 400, a system scan may automatically initiate the scanning. The decision to scan or not scan may be made on the basis of configurable system policy. In an example depicted in this figure three elements are included in the scan: system, memory, and network; however additional components may be included in the scan scheduling. At step 405, if a system scan is required based on the schedule scan, data monitoring module 110 will proceed to step 420. At step 420, data monitoring module 110 may scan and copy from data store 150 all attachments introduced into the system. At step 410, if a memory scan is required based on the schedule scan, data monitoring module 110 will proceed to step 425. At step 425, data monitoring module 110 scan and copy for Data Analysis 120 module of all memory including firmware in the system. At step 415, if a packet scan is required based on the schedule scan, data monitoring module 110 will proceed to step 430. At step 430, data monitoring module 110 may scan and copy for Data Analysis 120 module of selected internal network packets of the system.

FIG. 4B illustrates a process flow of a scan performed by data monitoring module 110. At step 450, a scan of a system begins. At step 453, the data monitoring module determines if the scan should be active. If the scan is not active, data monitoring module 110 proceeds to step 456 and terminates. If the scan is active, data monitoring module proceeds to step 459 and reads in the scanned items for analysis. At step 462, data monitoring module 110 extracts the features necessary for Data Analysis 120. At step 465, data monitoring module 110 may normalize the features. At step 474, data monitoring module 110 determines whether the scan is complete. If all scanning for that respective component has been verified as complete at step 474, data monitoring module 110 proceeds to step 477 to record the results of the data scan in the Data Store 150 module. If the scan has not been verified as complete, data monitoring module 110 returns to step 459. Once the data is recorded, a command to activate analysis and proceed with format conversion is sent to Data Analysis 120 for further analysis prior to being analyzed by spectral detector 132 (not illustrated). At step 480, data monitoring module 110 determines if the system in in a continuous mode and more scanning needs to be performed. If data monitoring module 110 is in a continuous scan mode, data monitoring module 110 returns to step 450, otherwise Data Analysis 120 module will terminate in module 489.

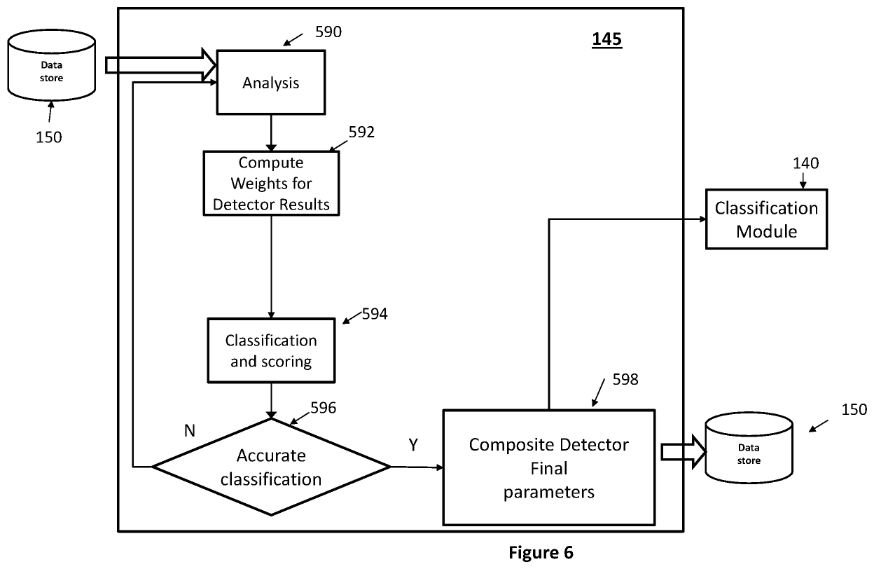

FIG. 6 illustrates the training process of employed by Model Training module 160 in training the Spectral Detectors 132. The Spectral Detectors 132 are an ensemble of detectors that examine code based on various spectral frequencies, such as acoustic, visual, and entropy spectral perspectives. Models are trained based on the results of Data Analysis 120 which have been recorded in Data Store 150. Model training is multi-dimensional in that the models are adaptive to code behavior and construct. They have the ability to classify code behavior and attributes regardless of whether the code is in the clear (i.e., uncompressed and unencrypted), compressed, or encrypted using a single model where the hyperparameters have been trained and adapted to operate in a multi-dimensional environment.

Examples of training methods to be employed include: Caffe-based Convolutional Neural Nets (CNN) Deep learning employing Forward Learning techniques; SigMal Static signal processing-based triage; R and SPSS modeler (time series, Classification, Association, Clustering, Decision tree); Python based Libraries (NumPy, NLTK, TensorFlow Keras, STATS model); Shannon Entropy & Wavelet Transform Decomposition (WTD) employing Dyatic Wavelet Analysis, Haar Discrete Wavelet Transform (DWT) decomposition; Hamming Weight, Short-time Fourier Transform (STFT) for entropy power levels that are fed into CNN; Principal Component Analysis (PCA) for feature extraction; Gaussian Mixture Mode (GMM) for clustering classification; Gist global image classification for image texture and spatial layout feature extraction; and N-Graphs strings.

At step 500, Model Training 160 retrieves relevant data from data store 150 for training of the spectral detector module 132. At step 505, Model Training 160 will determines if there is sufficient training data samples to start training of the respective detector. If there is not sufficient data, Model Training 160 returns to step 500 to retrieve additional data. If there is sufficient data, Model Training 160 proceeds to step 510 and selects a specific detector from the spectral detector 132 to be trained. At step 522, Model Training 160 partitions the data into training and test data. After partitioning the training data, at step 528 Model Training 160 builds the model based on the training data. After the model is built, at step 524 Model Training 160 evaluates whether the built model is ready for test data. If the built model is not ready for test data, Model Training 160 proceeds to step 520 to adjust model hyperparameters and to step 528 to rebuild the model until the model has been sufficiently trained to the first approximation. If the built model is sufficiently trained to the first approximation, Model Training 160 proceeds to step 530 where the test data will be used to verify the model can effectively detect and classify files. At step 532, Model Training 160 the results may be used to compute the model's precision using one or more know methods such as, for example, Receiver Operating Characteristics (ROC). At step 534, Model Training 160 determines whether the precision of classification and scoring meets acceptable thresholds. If the precision is not met, Model Training 160 proceeds to step 526 where the model's hyperparameters are adjusted for model retraining, before proceeding to step 522. If the precision of classification is met, Model Training 160 proceeds to step 536 to store model and its associated hyperparameters in Data Store 150. At step 550, Model Training 160 selects the best model located in data store 150. At step 560, Model Training 160 finalizes the selected model and sends the finalized model to classification module 140 for correlation of scores to a threat class (e.g., benign, suspicious, malicious). At step 544, Model Training 160 determines whether there are more Spectral detectors to be trained, if yes Model Training 160 returns to step 510, otherwise, model training is complete and terminates in step 548.

FIG. 6 illustrates the training process employed by Classification Training module 145 when training the classification module 140. At step 590, Classification Training module 145 performs entropy analysis on the output from the spectral detectors 132 stored in Data Store 150. At step 592, Classification Training module 145 computes detector weights based on the entropy analysis. At step 594, classification and scoring is performed. At step 596, Classification Training module 145 determines whether the classification and scoring results have an acceptable false alarm threshold. If the threshold is not met, Classification Training module 145 returns to step 590 for further analysis which will restart the tuning process until the threshold has been met. If the threshold is met, Classification Training module 145 proceeds to step 598 where the final rules and score parameters per class are stored in the Data Store 150, and the final rules are sent to classification module 140 for use at run-time.

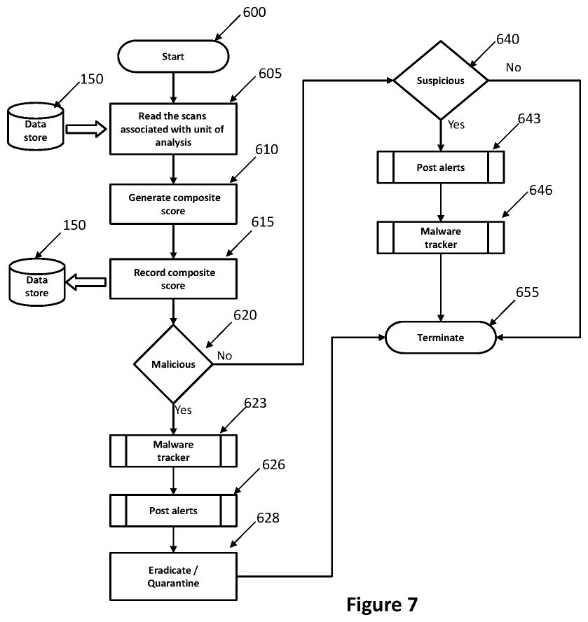

FIG. 7 illustrates the operation of the classification module 140 that will take scores, and metadata from each of the detectors in the spectral detectors module 132. It then computes an aggregate score to ensure that the final classification and score of the entity under investigation is not biased by any single detector of the spectral detectors module 132. As previously mentioned, the results of the analysis and scoring by the spectral detectors module 132 are stored in the Data Store 150. Step 600 of the Classification module 140 may not proceed unless each detector of the spectral detectors module 132 has completed its work. Once the Classification module 140 begins operation, step 605 to read in the the spectral detectors module 132 results from data store 150. Once the results have been read in, at step 610 the Classification module 140 computes the aggregate score for the entity. At step 615 the score will be recorded and stored in the Data Store 150. At step 620 the Classification module 140 examines the score and determines whether the entity has been classified as malicious. If the entity is malicious, at step 623 the Classification module 140 will call the Malware tracker 170 which determine whether one or more of these conditions are true: this malware is an offspring of an earlier detected malware or it has moved to another area of the system or is a new detection. At step 626, the information is given to User Event Monitor 180 which will deliver alerts to a system administrator. At step 628, the information is passed to quarantine processor 190 for quarantine action and then the Classification module 140 terminates at step 655. If the entity is not malicious, at step 640 the Classification module 140 determines whether the entity is suspicious. If the entity is suspicious, at step 643 the information is given to User Event Monitor 180 which will deliver alerts to a system administrator. At step 628, the information is passed to quarantine processor 190 for quarantine action and then the Classification module 140 terminates at step 655. If the entity is not suspicious, the entity has been classified as benign and control terminates at step 655.

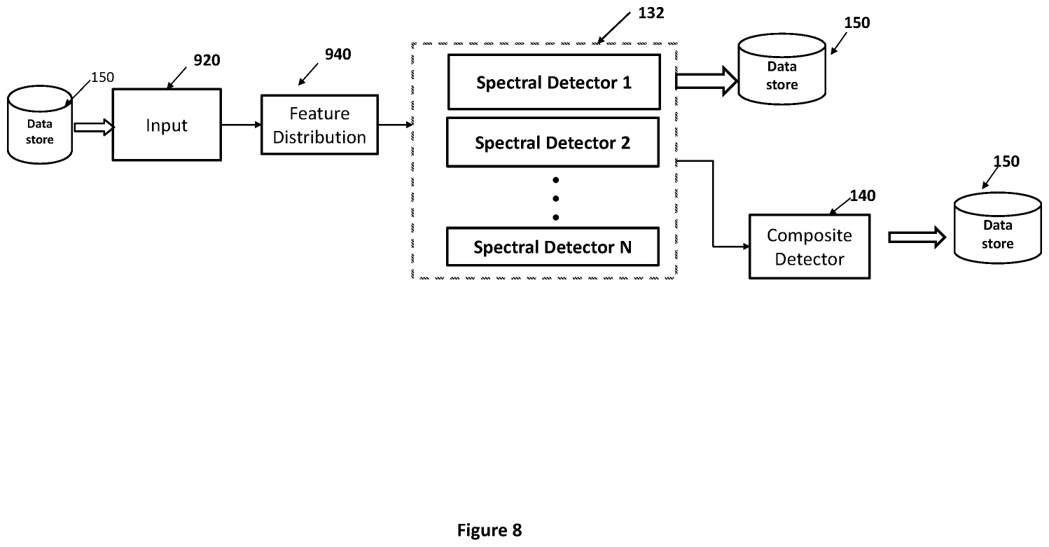

FIG. 8 illustrates the operation of the Spectral Detector 132, which includes multiple independent detectors. The input 920 reads the features from the Data Store 150. Extracted features are passed to Feature Distribution 940. Those features which are subject to spectral analysis are passed to the spectral detectors 132. Some features may be subject to both types of analysis. Policy, not illustrated, determines how the features are distributed between the detector classes. Within the Spectral Detectors 132 there is a component that computes a composite score (not illustrated). The composite score computation may use different algorithms. The spectral detectors 132 write their individual score to the Data Store 150, the composite score of the spectral Detectors 132 is also written to the data store 150. Finally, the composite score is passed to the classification module 140. Examples of techniques that could be used for either Spectral detectors include but are not limited to: Thermal or Entropy Detector employing Shannon Entropy Analysis, Wavelet Transform and Convolutional Neural Nets (CNN); Acoustic Spectral Analyzer Detector; and GIST Image Feature Detector.

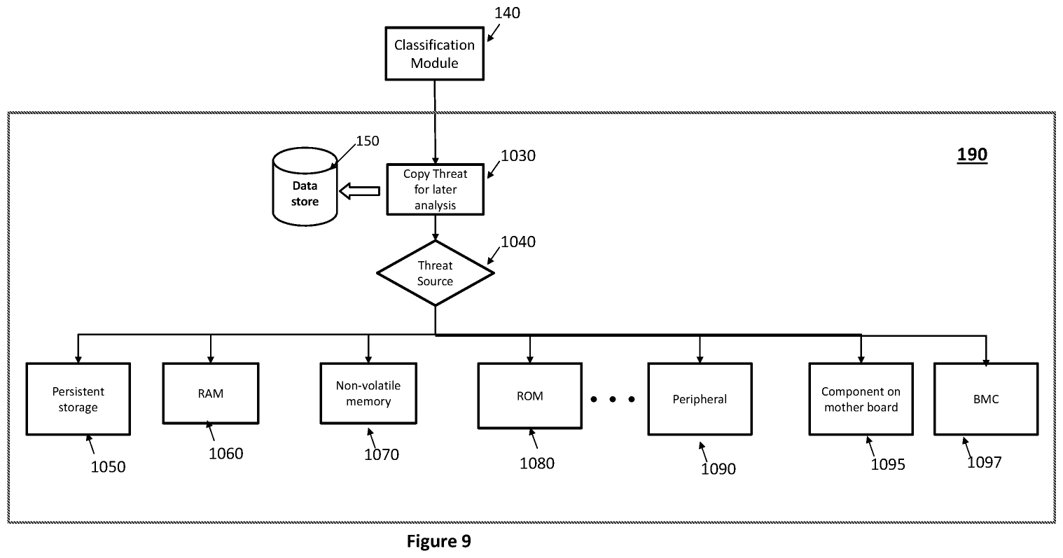

FIG. 9 illustrates the operation of the Quarantine Processor 190. The quarantine process will apply software and/or hardware techniques to neutralize and isolate suspected threats. Policy will determine which classifications are quarantined. Items that are classified suspicious may be restricted, without a full quarantine. This component of the solution will have architecture and configuration-specific dependencies. The threats that are classified malicious by the classification module 140 are passed to Quarantine processor 190. Malicious threats are recorded 1030 in the Data Store 150. The metadata which include entity ID, Score, Class time of scan-analysis, location, type and peripheral ID are be sent to Threat Source 1040. Threat Source 1040 distributes the threat to the correct component of quarantine based on its type. The potential quarantine methods and target components may include but are not limited to: Persistent storage, for example, disk 1050; RAM 1060; Nonvolatile Memory 1070; ROM 1080; Peripheral 1090; Component on the motherboard 1095; and BMC 1097. Upon completion of Quarantine, control will return to Data Monitoring 110. The results of quarantine processing will be recorded in logs. Items that are classified suspicious may be restricted, without a full quarantine.

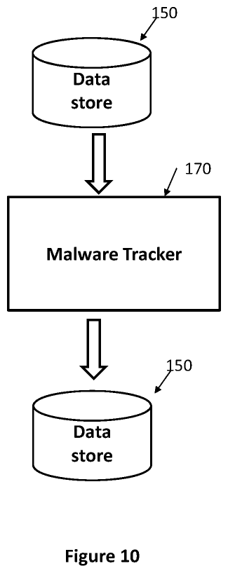

FIG. 10 illustrates the operation of the Malware Tracker module 170. This component reads the Data Store 150 and analyzes the report from all systems of computing device 900 recorded in the Data Store 150. Malware tracking module 170 utilizes the results of the analysis of each Malware Detection System to determine whether the same malware is present in multiple locations within the computing device 900. The Malware Tracker 170 uses techniques such as Jaccard-MinHashing for co-occurrence classification to correlate and track entities of interest. It assigns a tracking number to each unique reported instance. It augments the information in the Data Store 150 with the tracking number. This information is used to determine the prevalence of an attack within an infrastructure. The malware tracker is driven by policy, not illustrated, which determines when items of interest are passed to the User Event Monitor 180.

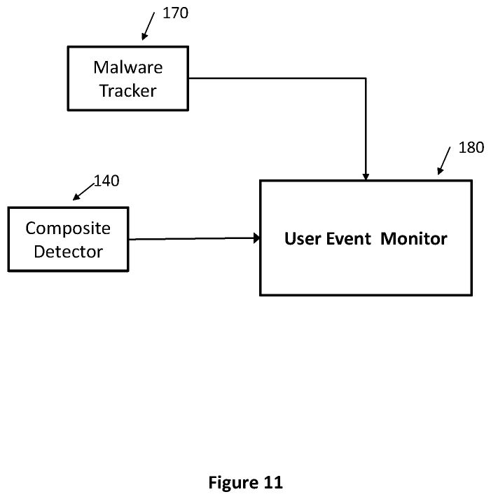

FIG. 11 illustrates the operation of the User Event Monitor module 180. This component of the solution sends alerts with detailed information to an end-user of all detected malicious and suspicious files. The targets and methods of the notification are determined by policy and include things such as console, email, text messaging an automated security system. Automated security systems includes existing STEM (security information and event management) systems. Policy determines which information from the classification module 140 and the Malware Tracker 170 is forwarded. A log of notifications may optionally be kept in the Data Store 150 (not illustrated). Alerts include but are not limited to: Memory type (e.g., RAM, cache, flash); Memory location; Alert class (e.g., suspicious, malicious); Threat type: (e.g., firmware, BIOS, file); Alert ID; Malware type (e.g., poly, meta); and Malware iteration.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A computer system for monitoring operation of the computer system, the computer system comprising one or more processors, one or more computer-readable memories, and one or more computer-readable storage devices, and program instructions stored on at least one of the one or more storage devices for execution by at least one of the one or more processors via at least one of the one or more memories, the program instructions comprising:
retrieving data from physical components of the computer system;
converting the data to at least one spectral format;
analyzing the converted data with a spectral detector; and
based on detecting a code anomaly by the spectral detector, performing a remediation action of the code anomaly.

2. The system of claim 1, wherein the at least one spectral format comprises an acoustic format.

3. The system of claim 1, wherein the at least one spectral format comprises an infrared format.

4. The system of claim 1, wherein the at least one spectral format comprises a visual format.

5. The system of claim 1, wherein the spectral detector is a machine learning algorithm trained using converted data of known malware.

6. The system of claim 1, wherein the remediation action comprises a quarantine of the code anomaly.

7. The system of claim 1, wherein the remediation action comprises tracking the code anomaly.

8. The system of claim 7, wherein the spectral detector is updated based on tracking the code anomaly.

9. The system of claim 1, wherein the code anomaly comprises compressed data.

10. The system of claim 1, wherein the code anomaly comprises encrypted data.

11. A method for detecting anomalous code, the method comprising:
retrieving data from physical components of the computer system;
converting the data to at least one spectral format;
analyzing the converted data with a spectral detector; and
based on detecting a code anomaly by the spectral detector, performing a remediation action of the code anomaly.

12. The method of claim 11, wherein the at least one spectral format comprises an acoustic format.

13. The method of claim 11, wherein the at least one spectral format comprises an infrared format.

14. The method of claim 11, wherein the at least one spectral format comprises a visual format.

15. The method of claim 11, wherein the spectral detector is a machine learning algorithm trained using converted data of known malware.

16. The method of claim 11, wherein the remediation action comprises a quarantine of the code anomaly.

17. The method of claim 11, wherein the remediation action comprises tracking the code anomaly.

18. The method of claim 17, wherein the spectral detector is updated based on tracking the code anomaly.

19. A computer program product for detecting anomalous code, the computer program product comprising one or more computer-readable storage devices and program instructions stored on at least one of the one or more tangible storage devices, the program instructions comprising:
retrieving data from physical components of the computer system;
converting the data to at least one spectral format;
analyzing the converted data with a spectral detector; and
based on detecting a code anomaly by the spectral detector, performing a remediation action of the code anomaly.

20. The computer program product of claim 19, wherein the at least one spectral format comprises an acoustic format.

21. The computer program product of claim 19, wherein the at least one spectral format comprises an infrared format.

22. The computer program product of claim 19, wherein the at least one spectral format comprises a visual format.

23. The computer program product of claim 19, wherein the spectral detector is a machine learning algorithm trained using converted data of known malware.

24. The computer program product of claim 19, wherein the remediation action comprises tracking the code anomaly.

25. The computer program product of claim 24, wherein the spectral detector is updated based on tracking the code anomaly.
